(19) United States
(12) Patent Application Publication
(10) Pub. No.: US 2015/0242814 A1
(43) Pub. Date: Aug. 27, 2015

(54) Systems and methods for handling social digital accounts and assets upon death or incapacitation

(71) Applicant: Rana A. Saad, Gaithersburg, MD (US)

(72) Inventor: Rana A. Saad, Gaithersburg, MD (US)

(21) Appl. No.: 13/999,400

(22) Filed: Feb. 24, 2014

(51) Int. Cl. G06Q 10/10; G06Q 50/00; G06Q 50/18

(52) U.S. Cl. CPC G06Q 10/107; G06Q 50/186; G06Q 50/01

(57) ABSTRACT

A system to allow users to specify how they would like to treat their digital assets embedded in their online and social accounts upon their death, by choosing one or a mix of numerous options for online verification and confirmation of a person's death by comparing against the online death records of all the States. A System and protocol for second level verification of the death from the next-of-kin or a person designated by the user to be passed on to the beneficiary.

### BACKGROUND OF THE INVENTION

(1) Field of the Invention

This invention relates generally to the field of digital social networks, online accounts, and digital assets. More particularly, the invention relates to methods and systems related to systematic and organized handling of online accounts, social network accounts and pages, and digital assets upon death of the individuals who own such assets. Computer systems and hand held devices, collectively called computing devices, are continuing to grow their capacity in several dimensions: permanent storage, networking bandwidth, memory, processing power, geo-location services, and wireless communication services. Mobile computing devices that allow for on the go digital interactions include regular phones with text capability, smartphones, tablets, and laptop computers. Users of these computing devices now can participate in real time on the go in digital social networks. Popular social network examples include Twitter, Facebook, LinkedIn, Youtube, Pinterest, Vine, Instagram and Google+. Often people cross link these social networking service such that a posting on one automatically shows up on their accounts on the other social networks.

People throughout their lives create accounts on multiple online and social platforms. In some cases people create multiple accounts on the same online or social platform.

These accounts become repositories of people's pictures, videos, documents, music, intellectual property, writings, artwork, software, and other forms of digital assets.

People also use online storage solutions in the internet ‘cloud’. These services include services like dropbox.com, Skydrive, Googledrive, box.com and others. These repositories are protected with a user name and password. People are able to store their photos, videos, documents, or any other digital assets online.

Generally, upon the death of an individual, their digital assets, online and social accounts and associated digital Intellectual Property Rights (IPR) become inaccessible. While individual online and social service providers may provide localized account closure procedures, there are many limitations and disadvantages.

Disadvantages include:

Only some online and social network service providers have any ability to deal with the accounts whose owners have passed away.

Of those online and social network service providers that provide a way for handling the ‘orphan’ accounts, there are no standard interfaces or features.

In the absence of a standard and centralized system and method, often people are unaware of and unable to specify during their lifetimes what they would like to do with their online account and assets.

(2) Description of the art including information disclosed under 37 CFR 1.97 & 1.98

The art described in the drawings of the invention are unique and we have found only one published application that is similar in nature to this invention. Please see “Management and dispersal of social media accounts” US 20120016803 A1.

### BRIEF SUMMARY OF THE INVENTION

The following summary provides an overview of various aspects of the invention described in the context of the related inventions incorporated-by-reference earlier herein (the “related inventions”).

This summary is not intended to provide an exhaustive description of all of the important aspects of the invention, nor to define the scope of the invention. Rather, this summary is intended to serve as an introduction to the detailed description and figures that follow.

In view of the aforementioned deficiencies in existing methods and systems of handling the online accounts and digital assets upon a person's death, there is a need for a new system and method for Handling Online and Social Accounts and Digital Assets Upon Death that provides the following functions:

A single centralized site ‘portal’ where users are able to view and configure all their online, social, and online ('cloud') storage accounts such that each account is handled according to the user's ‘will’.

Allow users to, during their lives, specify how they would like each of their accounts in the event of their passing, by choosing one of the following: Close the account, or ‘Memorialize’ the account, i.e.; freeze the account or its public facing page, with a message about the person's passing away, or replace the account or its main page with a pre-created or pre-selected memorial page.

Allow users to specify if and how they would like to notify the people interacting with their online or social account after their death:

Sending an online message or an automated email to everyone who sends an email or ‘posts’ to the person's page, or sending an online message or an automated email to a pre-specified list of next-of-kin and friends selected by the user during their lifetime.

Allow users to specify how they would like to treat their digital assets embedded in their online and social accounts upon their death, by choosing one or a mix of the following options:

Removing and permanently deleting assets, or passing on the digital assets to a specified person, or ‘donating’ certain digital assets and Intellectual Property Rights (IPRs).

A System for online verification and confirmation of a person's death by comparing against the online death records of all the States.

A System and protocol for second level verification of the death from the next-of-kin or a person designated by the user.

### BRIEF DESCRIPTION OF THE SEVERAL VIEWS OF THE DRAWINGS

FIG. 1: is the first step in the process.

FIG. 2: is the second step of the process.

FIG. 3: is the third step of the process.

FIG. 4: is the fourth step of the process.

FIG. 5: is the fifth step of the process.

FIG. 6: is the sixth step of the process.

FIG. 7: is the seventh step of the process.

### DETAILED DESCRIPTION OF THE PROFFERED EMBODIMENT

The subject matter of the present invention is described with specificity to meet statutory requirements.

However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

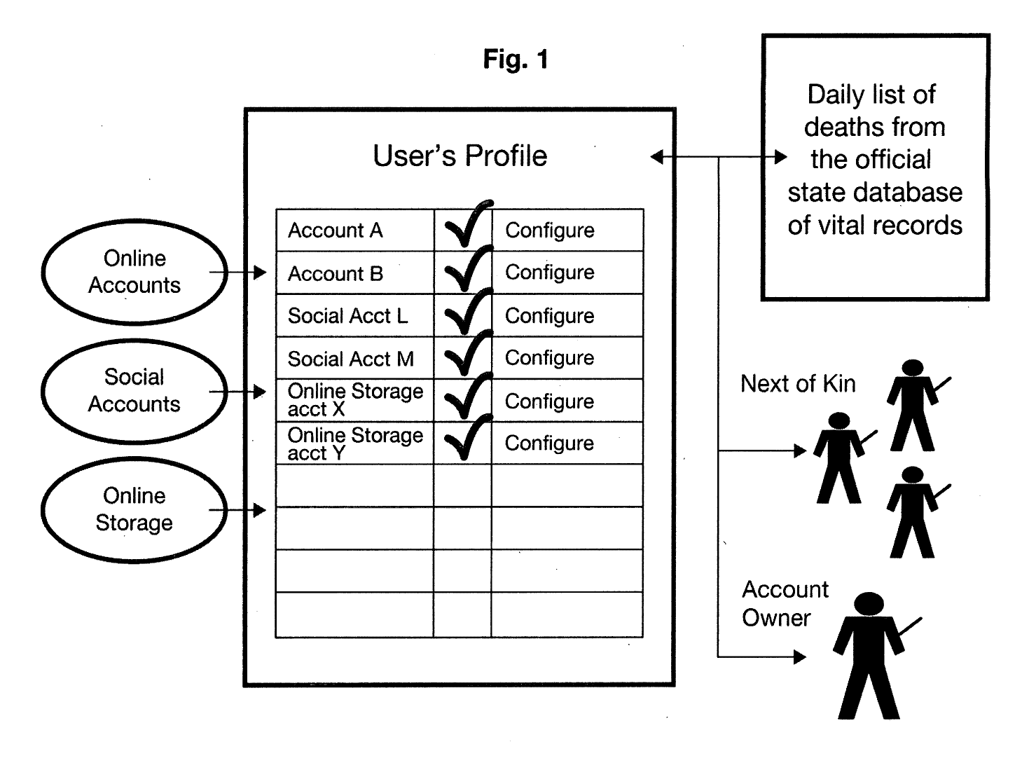

FIG. 1: Depicts the high level overall system. The system's user creates a profile during their lifetimes as a subscriber to the system. This profile allows the user to specify those online accounts, social media accounts, and digital storage accounts that they would like the system to affect. The figure also depicts the Three Tier verification process to confirm to confirm the death of the person.

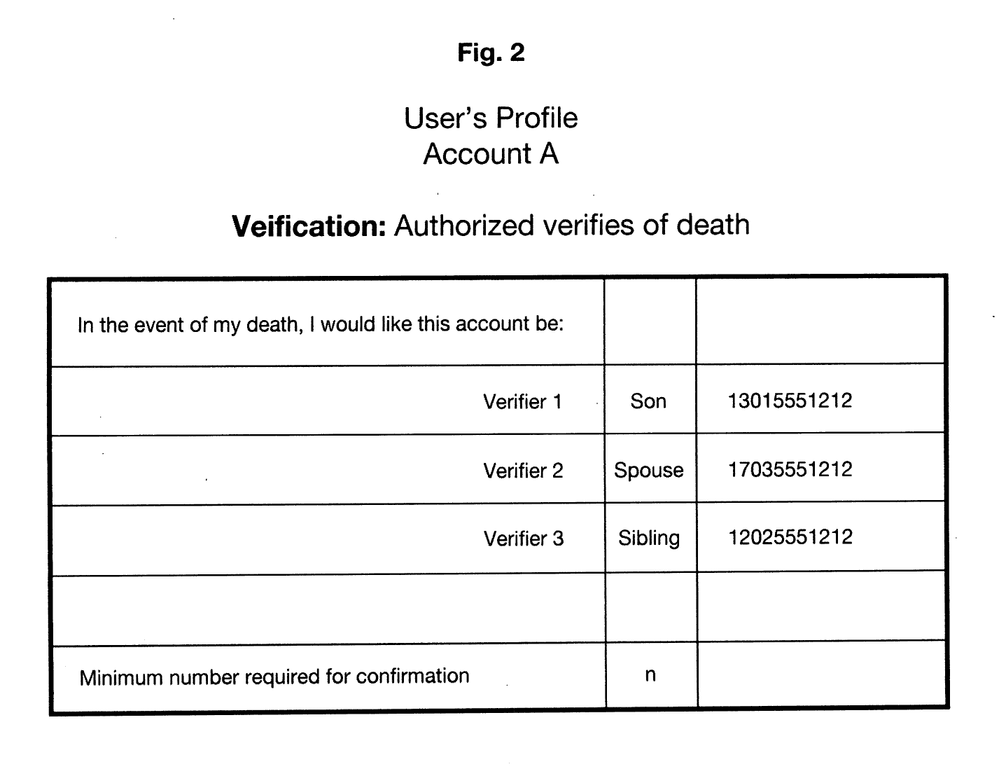

FIG. 2: Depicts the method and process for setting up the user's profile so that during their lifetime, the user sets up a list of next-of-kin, friends, or any persons who can confirm the death of the profile owner. The user can require more than one person's verification for confirmation.

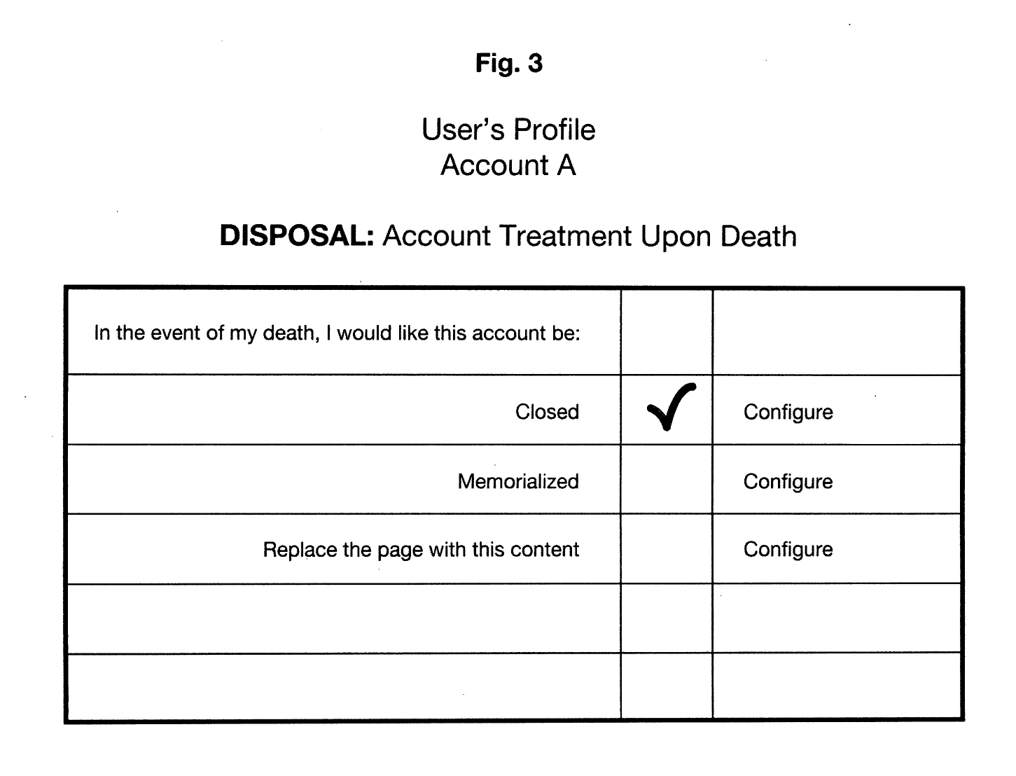

FIG. 3: Depicts the method and process for setting up the user's profile so that during their lifetime, the user sets up how they would like their online or digital account to be treated upon their death. The options include Closure and removal of the account, Memorializing the account by ‘freezing’ the account in its current state with no further modifications allowed, and Replacing the online account with a user specified content, e.g.; a static web page or image.

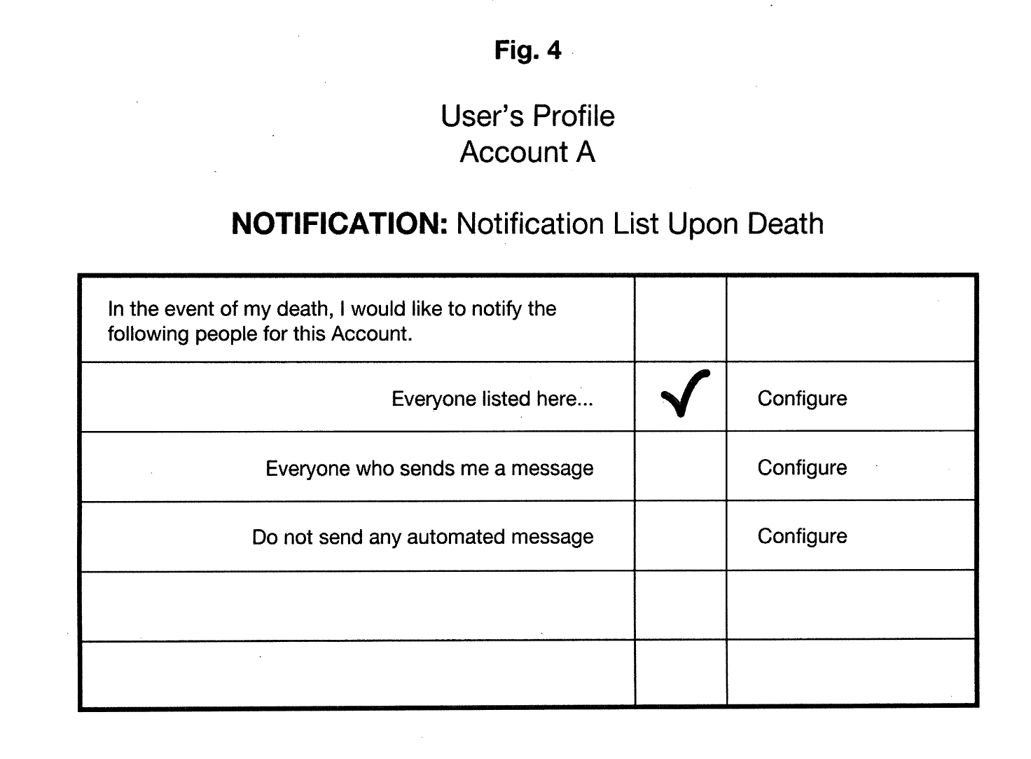

FIG. 4: Depicts the method and process for setting up the user's profile so that during their lifetime, the user sets up a list of people to notify in the event of death, specific to this particular account. This list is derived from contacts from the account.

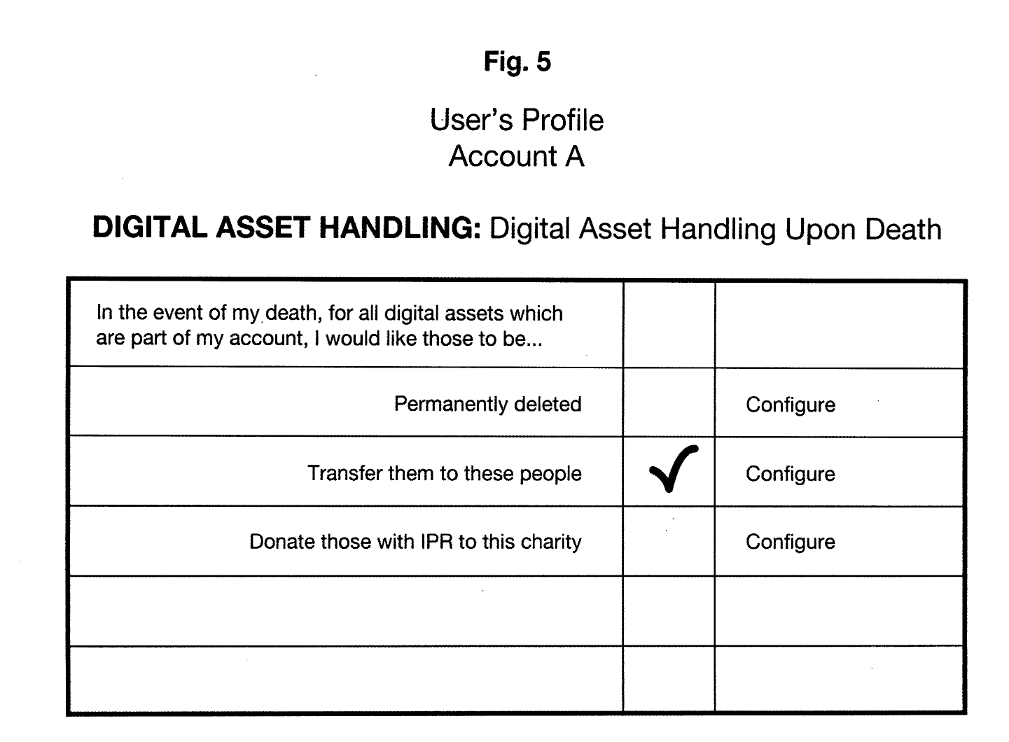

FIG. 5: Depicts the method and process for setting up the user's profile so that during their lifetime, the user sets up how they would like their digital assets to be treated upon their death. The options include: Permanently deleting the assets, Transferring the assets to the specified persons, and Donating the digital assets and rights to a specified charity or organization.

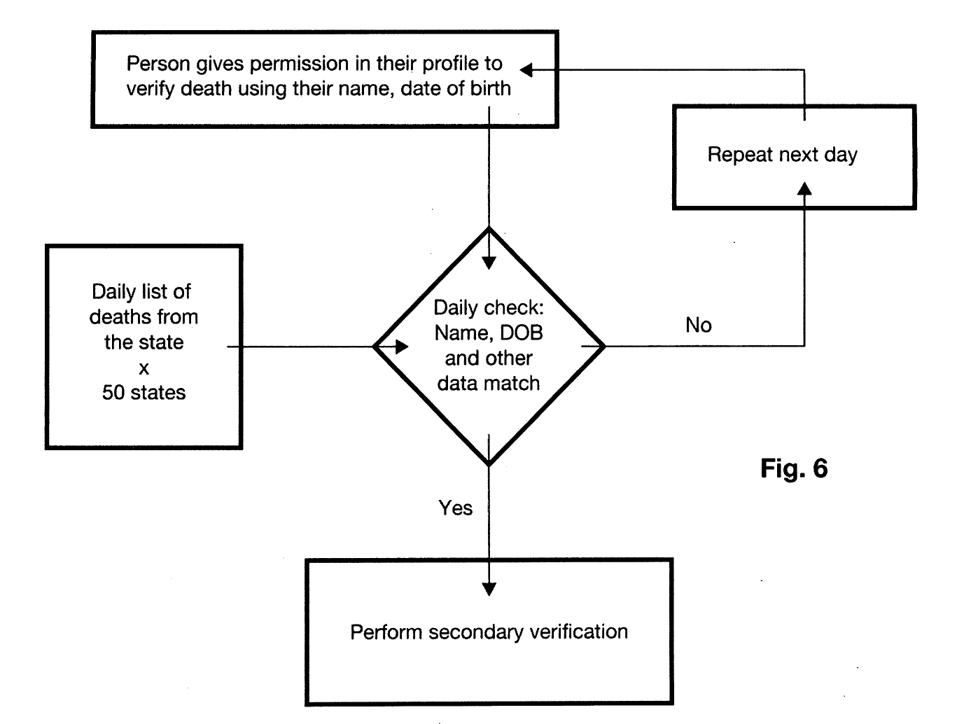

FIG. 6: Depicts the first tier of the Three Tier Verification Process. The process involves a ‘proactive’ daily lookup of the official list of deaths from the vital records databases of all 50 states. In case there is a match of the user's name and social security number, the second and third tier verification is invoked. If there is no match for the particular record, the process is repeated next day.

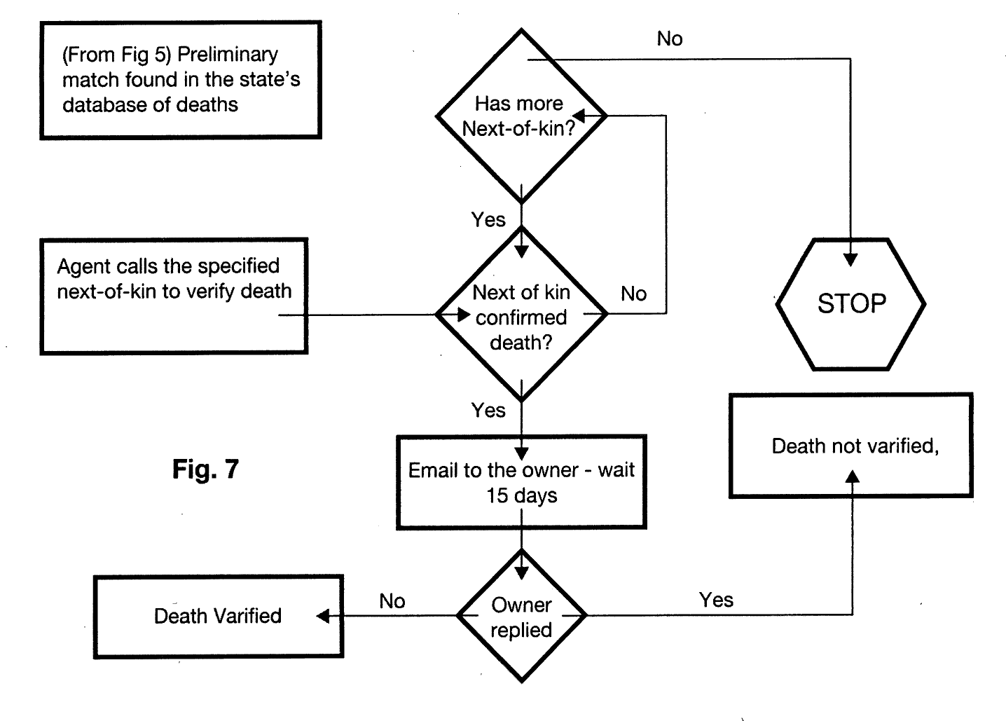

FIG. 7: Depicts the Second and the Third Tiers of the Verification Process. The Second Tier involves an Agent contacting user's specified list of Verifiers. If a specified minimum number of listed Verifiers fail to verify the death, it is established that the death did not take place, and the Verification Process is stopped. If a specified minimum number of Verifiers confirm the death, the Third Tier of Verification is invoked. At the Third Tier, the system generates a verification electronic mail (‘email’), and sends it to the deceased person's specified primary email address. The system then waits for 15 days before establishing that the person is deceased.

The present invention is not limited to the applications disclosed herein, but may be utilized for any type of media or other application to enable analysis and visualization of social events.

From the foregoing description, it will be appreciated that the invention makes available a novel system and method for the analysis and visualization of social events.

Having described some embodiments of the invention, it is believed that other modifications, variations and changes will be suggested to those skilled in the art in view of the teachings set forth herein. It is therefore to be understood that all such variations, modifications and changes are believed to fall within the scope of the present invention.

What is claimed is:

1. A system for handling digital, social accounts, and digital assets upon death comprised of:
a system for a person to specify authorized verifiers for their death during their lifetimes which includes the option to specify a minimum number of verifications;
a system that also includes incapacitation in addition to death;
a system that includes the ability to specify the following items in the profile in the event of their death;
a list of people to notify with the action to take on the digital and social accounts as the treatment of digital assets owned by the person.

2. The system wherein the verification of the account holder's death is established through a three tiered confirmation comprised of:
an automatic lookup verification from the official state database(s) of vital records;
a direct confirmation through the specified authorized verifiers in the account holder's profile;
a confirmation email sent with a mandatory no-response waiting period;
a daily lookup of the registered profiles in the system against official state database of vital records and deaths;
a person's ability to specify verifiers and a minimum number of verifiers for the person's death;
a final step of verification email sent to the account holder to verify the person is indeed dead;
a specified period of time after and the person has not responded;
a process of two other tiers of verification are complete such as the person's death is assumed confirmed and subsequent requested actions are performed.

3. The system for taking one or more of the following actions upon successful verification of the death of the account holder comprised of:
a system in which during their lifetime the account holder chooses the action to take in the event of their death for each of the digital or social account in their profile;
a system for removing or updating the user's digital account upon their death;
a system for removing or transferring the user's digital assets upon their death;
a system of memorializing or freezing the digital accounts upon a person's death;
a system for replacing a person's digital account with a static page or content.
